(19) United States
(12) Patent Application Publication
(10) Pub. No.: US 2023/0367077 A1
(43) Pub. Date: Nov. 16, 2023

(54) EXPANDED BEAM FIBER OPTIC CONNECTOR

(71) Applicant: BULGIN LIMITED, Cambridge (GB)

(72) Inventors: Jose Luis Latre Espuna, Cambridge (GB); Thisen Bird, Cambridge (GB)

(21) Appl. No.: 18/316,794

(22) Filed: May 12, 2023

(30) Foreign Application Priority Data
May 13, 2022 (GB) 2207007.2

(51) Int. Cl. G02B 6/32; G02B 6/38

(52) U.S. Cl. CPC G02B 6/322; G02B 6/3853; G02B 6/3846; G02B 6/3879

(57) ABSTRACT

An expanded beam fibre optic connector and a cable management system for an expanded beam fibre optic connector. The expanded beam fibre optic connector comprises an insert comprising one or more cylindrical insert bores each having an insert bore diameter along a length of the insert bore, and a sleeve and a lens disposed in each insert bore. The single diameter insert bore simplifies alignment between the sleeve(s) and the lens(es). The cable management system comprises an inner housing and an outer housing, an insert configured to hold a termination of one or more optical fibres of an optical fibre cable, and an inner crimp configured to grip an outer jacket of the optical fibre cable. The inner crimp and the inner housing comprise engagement surfaces configured to engage with one another and thereby prevent rotation of the inner housing relative to the optical fibre cable to prevent twisting.

### TECHNICAL FIELD

This disclosure relates to an expanded beam fibre optic connector. This disclosure also relates to a cable management system for an expanded beam fibre optic connector.

### BACKGROUND

Expanded beam fibre optic connectors are typically employed in applications where it is desirable to reduce the impact of dirt or misalignment on the connection between two optical fibres, such as harsh, outdoor environments. However, it is important that the alignment of components (e.g. optical fibres and lenses) within the connectors be as precise as possible to minimise light losses in the connectors themselves. Furthermore, it is important to minimise twisting of the optical fibres, as this can also cause light losses. Often, expanded beam connectors are assembled in the field, without access to specialised precision tools.

### SUMMARY

The present disclosure provides an expanded beam fibre optic connector according to claim 1 appended hereto, and a method of manufacturing an expanded beam fibre optic connector according to claim 9 appended hereto.

The expanded beam fibre optic connector may enable easy alignment of optical fibres and lenses in the field, as well as a simplified manufacturing process.

The present disclosure also provides a cable management system for an expanded beam fibre optic connector according to claim 16 appended hereto.

The cable management system may enable a straightforward way of preventing twists in optical fibres in the field without specialised equipment.

Further advantageous embodiments are contained in the dependent claims, also appended hereto.

Described herein is an expanded beam fibre optic connector comprising:

an insert comprising one or more cylindrical insert bores, each insert bore having an insert bore diameter along a length of the insert bore;
a sleeve disposed in each insert bore, the sleeve having a sleeve outer diameter, the sleeve further comprising a cylindrical sleeve bore having a sleeve bore diameter;
wherein each sleeve bore is configured to receive a ferrule, in use, each ferrule having a ferrule outer diameter, wherein the ferrule outer diameter is smaller than the sleeve bore diameter; and
a lens disposed in each insert bore, each lens having a lens outer diameter substantially the same as the sleeve outer diameter;
wherein each sleeve and each lens is held in a press fit engagement.

It will be understood that, where the insert is intended for use with a multi-core optical fibre cable, the insert may comprise more than one first cylindrical bore.

In some examples, the connector described herein may be suitable for use with standard physical contact fibre ferrules, e.g. Lucent connector (LC) ferrules.

Alignment of the lens and the ferrule (which contains a terminated optical fibre) is critical to minimise light loss. As described herein, each insert bore has a single inner diameter, and alignment of each lens and ferrule is advantageously simply achieved using the sleeves, which are each disposed in the same bore as each respective lens. In contrast to known inserts having two coaxial bores of differing diameters, where alignment of both bores requires a high level of precision to minimise light loss, the combination of the sleeves and the single diameter insert bores advantageously enables a simplified manufacturing process.

Having each sleeve and lens held in a press fit engagement ensures that achieving secure alignment of the sleeve and the lens is advantageously further simplified.

In some known inserts, a butt joint or fibre stub is present between the optical fibre and the ferrule, and/or between the ferrule and the lens, which may assist with alignment between the ferrule and the lens but which can also cause light losses at the coupling point(s) between the optical fibre and the butt joint or stub. In contrast, the sleeve(s) described herein may further advantageously enable the ferrule(s) to be immediately adjacent (or to abut) each respective lens, further minimising light loss by minimising the number of coupling points between optical components.

When the insert is in use, each ferrule may abut a respective lens.

By having each ferrule abutting the respective lens in use, light loss may be minimised by minimising the number of coupling points between the optical fibre and the lens, for example in contrast to known inserts including a butt joint or fibre stub.

Each sleeve may comprise ceramic.

Preferably, each sleeve is a solid ceramic sleeve (that is, having no split down the length of the sleeve).

A ceramic sleeve advantageously exhibits excellent corrosion and chemical resistance, high strength and high fracture toughness, high hardness and wear resistance. In addition, a ceramic sleeve minimises the susceptibility of the sleeve to the effects of thermal expansion or contraction caused by temperature fluctuations.

Each sleeve may comprise zirconia.

A sleeve comprising zirconia advantageously exhibits excellent corrosion and chemical resistance, high strength and high fracture toughness, high hardness and wear resistance. In addition, a sleeve comprising zirconia minimises the susceptibility of the sleeve to the effects of thermal expansion or contraction caused by temperature fluctuations. Furthermore, ferrules for optical fibres often also comprise zirconia. A sleeve comprising zirconia may therefore thermally expand or contract at the same rate as the ferrule, advantageously maintaining substantially the same fit between the ferrule and the sleeve in use and so enabling easy replacement of the ferrule.

The insert may comprise brass.

Advantageously, brass is corrosion-resistant for harsh environments, durable, abundant, and easy to machine, improving the reliability of the connector and further simplifying the manufacturing process.

The sleeve bore diameter may be configured to provide a close clearance fit between each sleeve and respective ferrule, in use.

A close clearance fit between each sleeve and ferrule enables re-terminating of the optical fibre(s) by the end user with no specialist tooling. Furthermore, the ferrule can be easily replaced with any appropriate ferrule if necessary due to straightforward removal and replacement of a ferrule enabled by the close clearance fit.

The expanded beam fibre optic connector may further comprise a removable rear plate affixed to the insert; and a spring for each insert bore; wherein, in use, each spring is arranged between the rear plate and the respective ferrule, and surrounding a respective ferrule back end, to provide a force that urges the ferrule towards the lens.

The removable rear plate and the spring, in use, advantageously ensure that each ferrule is maintained in contact with each respective lens, minimising light loss, while also advantageously allowing easy access to the sleeve, ferrule, ferrule back end, spring, and the insert itself for inspection and/or replacement of components.

In some examples, the removable rear plate may be connected to the insert, in use, via a bolt.

A refractive index of each lens may be at least 1.85 at a wavelength of 850 nm.

The higher the refractive index, the closer a focal point of the lens will be to the surface of the lens. It is desirable that the focal point of each lens be as close to the surface of the lens as possible to minimise light losses.

As an example, the focal point of each lens may be around 16 μm or less from the surface of the lens.

Also described herein is a method of manufacturing an expanded beam fibre optic connector, the method comprising:

forming an insert;
forming one or more cylindrical insert bores, each insert bore having an insert bore diameter along a length of the insert bore;
providing a sleeve for each insert bore, each sleeve having a sleeve outer diameter; and
each sleeve further comprising a cylindrical sleeve bore having a sleeve bore diameter, wherein each sleeve bore is configured, in use, to receive a ferrule, each ferrule having a ferrule outer diameter, wherein the ferrule outer diameter is smaller than the sleeve bore diameter; and
providing a lens for each insert bore, each lens having a lens outer diameter substantially the same as the sleeve outer diameter;
press fitting one of the sleeves and one of the lenses into each insert bore.

It will be understood that, where the insert is intended for use with a multi-core optical fibre cable, the method may comprise forming more than one first cylindrical bore.

In some examples, a connector manufactured by the method described herein may be suitable for use with standard physical contact fibre ferrules, e.g. Lucent connector (LC) ferrules.

Alignment of the lens and the ferrule (which contains a terminated optical fibre) is critical to minimise light loss. As described herein, each insert bore has a single inner diameter, and alignment of each lens and ferrule is advantageously simply achieved using the sleeves, which are each disposed in the same bore as each respective lens. In contrast to known inserts having two coaxial bores of differing diameters, where alignment of both bores requires a high level of precision to minimise light loss, the present manufacturing method only requires each insert bore to be a single diameter bore and is therefore simplified.

By press fitting the sleeves and lenses into each respective insert bore, achieving secure alignment of each sleeve and respective lens is advantageously further simplified.

In some known inserts, a butt joint or fibre stub is present between the optical fibre and the ferrule, and/or between the ferrule and the lens, which may assist with alignment between the ferrule and the lens but which can also cause light losses at the coupling point(s) between the optical fibre and the butt joint or stub. In contrast, providing the sleeve(s) as described herein may further advantageously enable the ferrule(s) to be immediately adjacent (or abut) each respective lens, further minimising light loss when the connector is in use by minimising the number of coupling points between optical components.

Each sleeve may comprise ceramic.

Preferably, each sleeve is a solid ceramic sleeve (that is, having no split down the length of the sleeve).

A ceramic sleeve advantageously exhibits excellent corrosion and chemical resistance, high strength and high fracture toughness, high hardness and wear resistance. In addition, a solid ceramic sleeve minimises the susceptibility of the sleeve to the effects of thermal expansion or contraction caused by temperature fluctuations.

Each sleeve may comprise zirconia.

A sleeve comprising zirconia advantageously exhibits excellent corrosion and chemical resistance, high strength and high fracture toughness, high hardness and wear resistance. In addition, a sleeve comprising zirconia minimises the susceptibility of the sleeve to the effects of thermal expansion or contraction caused by temperature fluctuations. Furthermore, ferrules for optical fibres often also comprise zirconia. A sleeve comprising zirconia may therefore thermally expand or contract at the same rate as the ferrule, advantageously maintaining substantially the same fit between the ferrule and the sleeve in use and so enabling easy replacement of the ferrule.

The insert may comprise brass.

Advantageously, brass is corrosion-resistant for harsh environments, durable, abundant, and easy to machine, improving the reliability of the connector and further simplifying the manufacturing process.

The sleeve bore diameter may be configured to provide a close clearance fit between each sleeve and respective ferrule, when the connector is in use.

A close clearance fit between the sleeve and the ferrule enables re-terminating of the optical fibre(s) by the end user with no specialist tooling. Furthermore, the ferrule can be easily replaced with any appropriate ferrule if necessary due to straightforward removal and replacement of a ferrule enabled by the close clearance fit.

The method may further comprise:

forming a removable rear plate configured to be affixed to insert; and
providing a spring for each insert bore, each spring configured, when the connector is in use, to be arranged between the rear plate and the respective ferrule, and surrounding a respective ferrule back end, to provide a force that urges the ferrule towards the lens.

The removable rear plate and each spring, in use, advantageously ensure that the ferrule is maintained in contact with the lens, minimising light loss, while also advantageously allowing easy access to the sleeve, ferrule, ferrule back end, spring, and the insert itself for inspection and/or replacement of components.

In some examples, in use, the removable rear plate may be configured to be connected to the insert via a bolt.

A refractive index of each lens may be at least 1.85 at a wavelength of 850 nm.

The higher the refractive index, the closer a focal point of the lens will be to the surface of the lens. It is desirable that the focal point of each lens be as close to the surface of the lens as possible to minimise light losses.

As an example, the focal point of each lens may be around 16 μm or less from the surface of the lens.

Also described herein is a cable management system for an expanded beam fibre optic connector, the cable management system comprising:

an inner housing having a bore and in inner surface, a portion of the inner surface having a first engagement surface;
an outer housing, the outer housing comprising a front portion and a removable rear portion;
an insert housed in the inner housing, the insert being configured, in use, to hold a termination of one or more optical fibres of an optical fibre cable; and
an inner crimp configured, in use, to grip an outer jacket of the optical fibre cable;
wherein an outer surface of the inner crimp comprises a second engagement surface configured, in use, to engage with the first engagement surface for preventing rotation of the inner housing relative to the optical fibre cable.

When it comes to installing a connector to an optical fibre cable, it is crucial to avoid twisting of individual optical fibres and/or of the optical fibre cable, as any twisting may result in light losses.

In use, when the optical fibres are installed in the insert, the cable management system described herein advantageously maintains the fibres in as straight a position as possible and in a manner whereby the fibres can be easily replaced and rearranged, without requiring any specialised tools.

In use, the inner crimp and the cavity ensure that the inner housing does not rotate relative to the optical fibre cable when the inner crimp is disposed in the cavity. Therefore, when the insert is fixed to the inner housing, the insert also cannot rotate relative to the optical fibre cable, for example when the outer housing rear portion is removed. Twisting of the optical fibres is therefore advantageously prevented. In other words, the first engagement surface (of the inner surface of the inner housing) and the second engagement surface (of the inner crimp) may advantageously provide a secure lock that prevents unwanted rotation of the components of the connector/cable management system

In some examples, the first engagement surface may define a cavity having a polygonal cross section in a plane perpendicular to a longitudinal axis of the inner housing (the longitudinal axis being parallel to the axis of the optical fibre cable when the cable management system is in use). The second engagement surface may define a portion of the inner crimp having a correspondingly-shaped polygonal cross section (e.g. correspondingly shaped to fit in the cavity to prevent rotation) in a plane perpendicular to the longitudinal axis of the inner crimp (the longitudinal axis being parallel to the axis of the optical fibre cable when the cable management system is in use). For example, the polygonal cross section may be a hexagonal cross section. Alternatively, the polygonal cross section may comprise one or more non-convex vertices (e.g. a star-shaped polygon).

In another example, the second engagement surface of the inner crimp may be defined by one or more rods and the first engagement surface may be defined by one or more bores, wherein the rods are configured to be inserted into the one or more bores.

It will be understood that, in general, the second engagement surface (of the inner crimp) is configured to engage with the first engagement surface (of the inner surface) in the manner of a lock and key to prevent the inner housing from rotating independently of the optical fibre cable.

It will be understood that the inner crimp gripping the outer jacket of the optical fibre cable means that the inner crimp and the optical fibre cable cannot rotate independently of one another in use. In use, any suitable fitting may be employed to ensure that the inner crimp grips the outer jacket of the optical fibre, for example an outer crimp may be used to provide a compression fit between the inner crimp and the optical fibre cable.

Preferably, the front and rear portions of the outer housing are configured to mate with one another. It will be understood that the outer housing front and rear portions may comprise screw threads configured to mate with one another. In another example, the outer housing front and rear portions may be configured to be held together by a bayonet fitting or other suitable fitting.

The outer housing rear portion may be rotatable independently of the inner housing and the optical fibre cable (for example, in order to unscrew the outer housing rear portion from the outer housing front portion).

As the inner and outer housings are easily removable without tools, the cable management system described herein further advantageously enables in-process testing for connector losses prior to final assembly of the connector.

The inner housing may comprise a removable, or cut-out portion.

A removable portion may advantageously enable simplified inspection and adjustment of the optical fibres and/or the inner crimp, following removal of the outer housing, without requiring rotation or removal of the inner housing.

The inner housing may be transparent or translucent.

A transparent or translucent inner housing may further enable simplified inspection of the components of the connector (e.g. the optical fibres and their connections, in use).

The insert of the cable management system may further comprise one or more cylindrical insert bores, each insert bore having an insert bore diameter along a length of the insert bore; and the cable management system may further comprise:

a sleeve disposed in each insert bore, the sleeve having a sleeve outer diameter, the sleeve further comprising a cylindrical sleeve bore having a sleeve bore diameter;
wherein each sleeve bore is configured, to receive a ferrule, in use, each ferrule having a ferrule outer diameter, wherein the ferrule outer diameter is smaller than the sleeve bore diameter; and
a lens disposed in each insert bore, each lens having a lens outer diameter substantially the same as the sleeve outer diameter;
wherein each sleeve and each lens is held in a press fit engagement

It will be understood that, where the insert is intended for use with a multi-core optical fibre cable, the insert may comprise more than one first cylindrical bore.

In some examples, the connector described herein may be suitable for use with standard physical contact fibre ferrules, e.g. Lucent connector (LC) ferrules.

Alignment of the lens and the ferrule (which contains a terminated optical fibre) is critical to minimise light loss. As described herein, each insert bore has a single inner diameter, and alignment of each lens and ferrule is advantageously simply achieved using the sleeves, which are each disposed in the same bore as each respective lens. In contrast to known inserts having two coaxial bores of differing diameters, where alignment of both bores requires a high level of precision to minimise light loss, the combination of the sleeves and the single diameter insert bores advantageously enables a simplified manufacturing process.

Having each sleeve and lens held in a press fit engagement ensures that achieving secure alignment of the sleeve and the lens is advantageously further simplified.

In some known inserts, a butt joint or fibre stub is present between the optical fibre and the ferrule, and/or between the ferrule and the lens, which may assist with alignment between the ferrule and the lens but which can also cause light losses at the coupling point(s) between the optical fibre and the butt joint or stub. In contrast, the sleeve(s) described herein may further advantageously enable the ferrule(s) to be immediately adjacent (or abut) each respective lens, further minimising light loss by minimising the number of coupling points between optical components.

### LIST OF FIGURES

We shall now describe the present invention by way of example only with reference to the accompanying drawings, in which:

FIG. 1 shows a longitudinal cross section of an expanded beam fibre optic connector according to an example;

FIG. 2 shows a longitudinal cross section of a cable management system for an expanded beam fibre optic connector according to an example;

FIG. 3 shows an exploded view a cable management system for an expanded beam fibre optic connector according to an example; and

FIG. 4 shows an exploded view of a cable management system according to a further example.

The features of the drawings are numbered as follows:
101 Insert
102 Lens
103 Ferrule
104 Sleeve
105 Rear plate
106 Spring
107 Ferrule back end
108 Bolt
201 Insert
202 Ferrule back end
203 Ferrule
204 Spring
205 Optical fibre
206 Inner housing
207 Inner housing removable portion
208 Outer housing rear portion
209 Outer crimp
210 Inner crimp
211 Optical fibre cable
212 Sleeve
214 Lens
216 Bolt
220 Outer housing front portion
230 Lock ring
240 Insert guide pin
301 Insert
302 Ferrule back end
303 Ferrule
304 Spring
305 Optical fibre
306 Inner housing
307 Inner housing removable portion
308 Outer housing rear portion
309 Outer crimp
310 Inner crimp
311 Optical fibre cable
401 Outer housing front
402 Lens
403 Insert guide pin
404 Insert
405 Insert o-ring
406 Sleeve
407 Ferrule
408 Ferrule back end
409 Spring
410 Back end plate
411 Bolt
412 Wave spring
413 Front seal
414 Lock ring
415 Outer housing internal o-ring
416 Outer housing external o-ring
417 Outer crimp
418 Inner housing cut-out portion
419 Inner housing front portion
420 Inner crimp
421 Cable seal
422 Cable cage
423 Outer housing
425 Pin hole

### DETAILED DESCRIPTION

### Expanded Beam Fibre Optic Connector

The alignment between a lens and a ferrule is one of the key challenges when it comes to minimising light loss in a fibre optic connector. Known arrangements tend to include complex and costly solutions due to the use of cutting edge technology and high precision engineering. The inventors of the expanded beam fibre optic connector described herein approached the issue of the lens-ferrule alignment by implementing a single bore hole in the insert, which simplifies the number of manufacturing operations and their complexity.

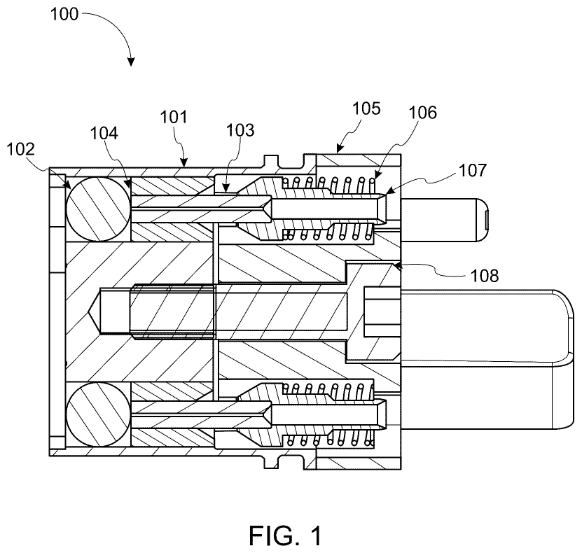

FIG. 1 illustrates a longitudinal cross section of an example expanded beam fibre optic connector 100 comprising an insert 101, the insert 101 comprising a plurality of single-bore insert bores (holes), the connector 100 further comprising a lens 102 and a sleeve 104 disposed in each insert bore. The sleeve 104 comprises a sleeve bore and is configured, in use, to receive a ferrule 103. In the example illustrated in FIG. 1, the lens 102 is a spherical ball lens. However, it will be appreciated that other lens shapes may be employed. For example, the lens 102 may be a cylindrical lens.

Merely as an example, the lens 102 may comprise Schott LASF 35.

It is desirable that the focal point be as close to the surface of the lens 102 as possible to minimise light loss. Merely as an example, the lens 102 may have a refractive index of at least 1.85 at a wavelength of 850 nm, with a focal point 16 μm from the lens surface.

The lens 102 is introduced from the front face of the insert 101 in the insert bore until is flush with the insert front face (i.e. a face of the insert 101 facing away from the optical fibre, in use). The insert 101 and the lens 102 have a press to ensure alignment between these components and secure the position of the lens 102.

In use, the ferrule 103 contains an optical fibre (not shown in FIG. 1), the end of the optical fibre being flush with the end of the ferrule 103 at which the optical fibre terminates. In use, the ferrule 103 is inserted into the sleeve bore from the back face of the insert 101 (i.e. the face opposite the front face) until it is in contact with the lens 102.

In order to ensure that the ferrule 103 is centred in relation to the lens 102 and also in contact with the lens 102, the inventors have found that a solid ceramic sleeve 104 made of zirconia (which may, in some implementations in use, be the same material as the ferrule 103) has proved to be advantageous.

The sleeve 104 not only ensures easy positioning of the ferrule 103, but also easily allows for the ferrule 103 to be replaced if necessary, improving the reusability of the connector 100.

The zirconia sleeve 104 has the following mechanical properties: excellent corrosion and chemical resistance, high strength and high fracture toughness, high hardness and wear resistance. Additionally, zirconia avoids changes in shape due to temperature variations, which is key to ensure reliable performance of the connector 100. The sleeve 104 may be formed by precision grinding to achieve small tolerances. The insert bore hole and the sleeve 104 have a press fit to ensure alignment between components. Furthermore, in use, the sleeve 104 and the ferrule 103 have a clearance fit to allow for easy replacement of the ferrule 103.

The insert 101 may comprise brass. Brass is advantageous due to its mechanical properties as well as its low cost. Brass is corrosion-resistant for harsh environments, durable, cost effective and easy to machine.

As discussed above, the ferrule 103 holds an optical fibre. More precisely, as illustrated in FIG. 1, the optical fibre is held in place by a ferrule back end 107. In use, the front of the ferrule 103 is held in position by the sleeve 104.

The connector 100 may further comprise a removable rear plate 105, and a spring 106 in contact with the rear plate 105. The ferrule back end 107 is surrounded by the spring 106, which forces the ferrule back end 107 (and therefore the ferrule 103) towards the lens 102. As illustrated in FIG. 1, the rear plate 105 may be fixable to the insert 101 via a bolt 108. As illustrated in FIG. 1, the bolt 108 passes through a clearance hole in the rear plate 105 and is threaded in the insert 101. The rear plate 105 therefore allows for easy access and inspection of the sleeve 104, ferrule 103, ferrule back end 107, and the spring 106, as well as permitting assembly.

### Cable Management System

When installing a connector and an optical fibre cable, it is crucial to have the cable in a position that is not twisted in order to minimise losses. Hence, the cable should be positioned as straight as possible. However, it can be difficult to avoid twisting the optical fibre cable and/or the individual optical fibre(s). The inventors have therefore identified a need for a cable management system that allows the end user to adjust the position of the cable without requiring any tools.

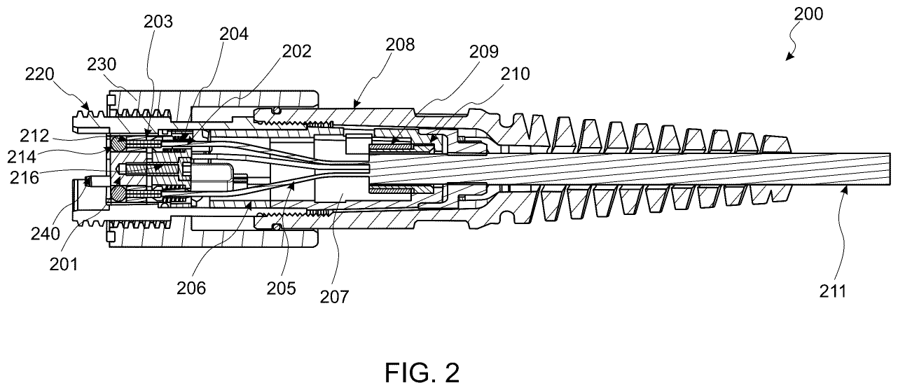

FIG. 2 illustrates an example of a cable management system 200 for an optical fibre cable 211. In the example illustrated in FIG. 2, the optical fibre cable 211 is a multi-core optical fibre cable, comprising more than one optical fibre 205.

The cable management system 200 illustrated in FIG. 2 comprises an insert 201, an inner housing 206, and an outer housing, the outer housing comprising a front portion (outer housing front portion) 220 and a rear portion (outer housing rear portion) 208. The cable management system 200 described herein may be suitable for use with an expanded beam fibre optic connector 100 substantially as described hereinabove, and the insert 201 may correspond substantially to the insert 101 illustrated in FIG. 1 and described hereinabove. The insert 201 of the non-limiting example illustrated in FIG. 2 includes a ferrule 203, a ferrule back end 202, a spring 204, a sleeve 212, a lens 214, and a bolt 216. These components may, in a non-limiting example, correspond to like components illustrated in FIG. 1 and described hereinabove. However, the cable management system 200 described herein may equally be suitable for use with any other fibre optic connector not described herein.

The cable management system 200 further comprises an inner crimp 210. In use, the inner crimp 210 may be held in place on an outer jacket of the optical fibre cable 211 by an outer crimp 209, e.g. via a compression fitting.

As further illustrated in FIG. 2, in use, in some non-limiting implementations, an insert guide pin 240, or dowel, may be inserted into the insert 201 to facilitate alignment with a corresponding connector. Furthermore, in use, in some non-limiting implementations, a lock ring 230 may be employed to hold two corresponding connectors together.

In use, the insert 201 holds in place a termination of each of one or more optical fibres 205 of the optical fibre cable 211. Once the optical fibre 205 is installed in the insert 201, the position of the optical fibre 205 is fixed. However, it is desirable that the optical fibre 205 be maintained as straight as possible between the insert 201 (e.g. between a ferrule back end 202 holding the optical fibre 205 at the insert 201) and the inner crimp 210.

When the cable management system 200 is fully assembled, the insert 201 and, where applicable, a rear plate, is housed in the outer housing front portion 220, and may be secured for example via a bayonet fitting or other fitting such that the insert 201 (and rear plate) may be easily removed.

Furthermore, when the cable management system 200 is fully assembled, the inner housing 206 is situated inside the outer housing, where the outer housing comprises the outer housing front 220 and rear 208 portions held together by mating screw threads.

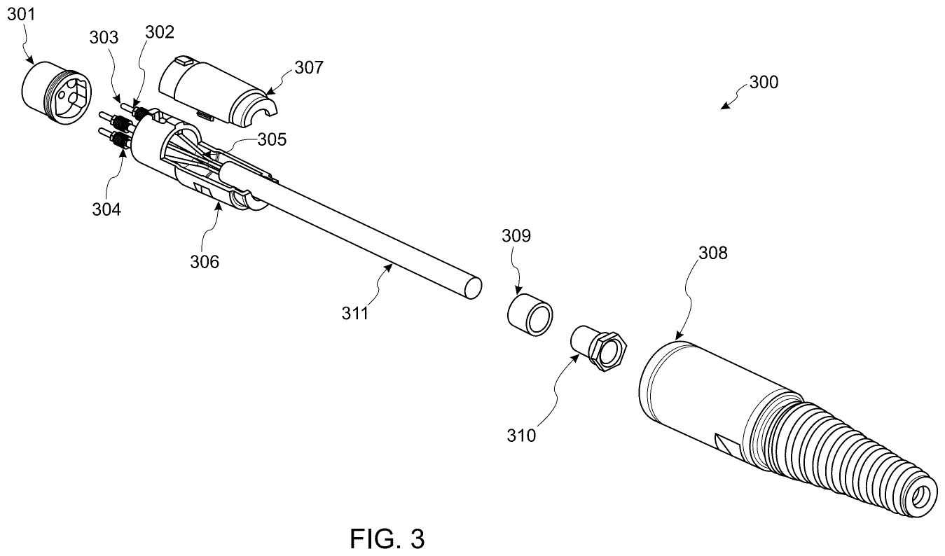

The inner housing 206 may comprise a removable portion 207 to enable easy access to the optical fibre(s) 205, for example for maintenance, testing, or inspection of the optical fibre(s) 205 and/or their connections. The removable potion 207 of the inner housing 206 is described in more detail below with reference to FIG. 3.

FIG. 3 provides an exploded view of a cable management system 300. The cable management system 300 illustrated in FIG. 3 corresponds generally to the cable management system 200 illustrated in FIG. 2, and comprises an insert 301, an inner housing 306, an inner crimp 310, and an outer housing rear portion 308. It will be appreciated that the outer housing front portion has been omitted in FIG. 3 for clarity.

FIG. 3 further illustrates a ferrule 303, a ferrule back end 302 and spring 304, an optical fibre cable 311 comprising one or more optical fibres 305, and an outer crimp 309, corresponding generally to like features in FIG. 2, when the cable management system 200, 300 is in use.

As illustrated in FIGS. 2 and 3, in order to gain access to the inner housing 206, 306, the outer housing rear portion is detached (e.g. unscrewed) and moved away from the inner housing front portion 207, 307. The inner housing 206, 306 may comprise a removable, or cut-out, portion 207, 307, enabling access to the inner crimp 210, 310 and/or the optical fibres 205, 305. The inner crimp 210, 310 has a specific shape (e.g. polygonal such as hexagonal) that fits in a same-shaped bore or cavity (in general, defined by an inner surface of the inner housing) of the inner housing 206, 306 (where said inner surface of the inner housing may be formed partly in the removable portion 207, 307). As the inner crimp 210, 310 grips the optical fibre cable 211, 311 in use (e.g. due to the outer crimp 209), once terminated the optical fibre cable 211, 311 is prevented from twisting relative to the inner housing. The inner housing 206, 306, the insert 201, 301, and the optical fibres 205, 305 are then all maintained at a particular angle relative to each other as determined by the shape of the inner crimp 210, 310. In other words, the inner crimp 210, 310 prevents the rotation of the inner housing 206, 306 and the optical fibre cable 211, 311 or optical fibres 205, 305 when the outer housing is removed to enable inspection. Hence, this arrangement provides a solution to the problem of twisted optical fibres that can otherwise have a considerable detrimental effect the performance of a connector.

In some examples, the inner housing 206, 306 and/or the removable portion 207, 307 may be transparent or partially transparent (e.g. translucent) to enable quick inspection of its interior (i.e. of the optical fibres 205, 305) when the outer housing rear portion 208, 308 is removed.

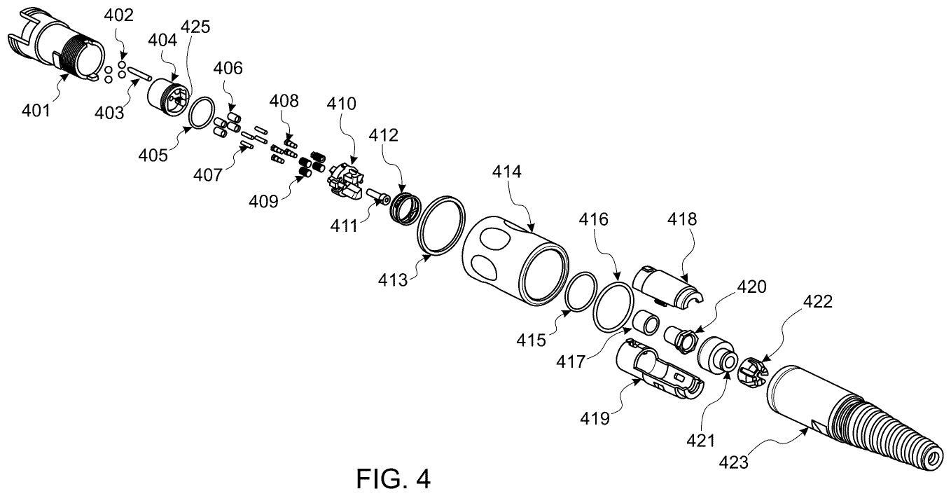

FIG. 4 illustrates an exploded view of a further example of a cable management system according to a non-limiting example implementation. Where present in those figures, certain components of the cable management system shown in exploded view in FIG. 4 may correspond to like components of the cable management system 200, 300 illustrated in use in FIGS. 2 and 3. However, it will be understood that FIG. 4 merely illustrates one specific implementation, and that any components illustrated in FIG. 4 that are not defined in the independent claims appended hereto are not to be considered as essential to the invention.

With reference to FIG. 4, a non-limiting example set of instructions for a method of assembling a cable management system on an optical fibre cable will now be described.

### First Sub-Assembly

Place a recently cleaned brass insert 404 face down onto a clean surface underneath a press tool. Using a pair of clean plastic tweezers, pick up one ceramic sleeve 406 and position it on top of one of 4 bore holes. Make sure that the ceramic sleeve 406 has the tapered face facing up.

Using a press tool, align the bore of the ceramic sleeve 406 to the point of the press tool, and pull the lever towards you to drive the ceramic sleeve 406 into the brass insert 404 until the ceramic sleeve is flush to the back of the brass insert 404. Repeat this process 3 more times so that each position (bore hole) has a ceramic sleeve 406 in place.

Turn the brass insert 404 over so that the face is now facing upward. With a suitable tool (e.g. a vacuum pen or a sticky nib pen) pick up one lens 402 and place it carefully into a bore in the insert 404. When the lens 402 is sat loosely in the bore, use the tool to position the lens 402 centrally in the bore hole.

Using the press tool, carefully align the tool with the centre of the ball lens 402, pressing firmly but carefully until the lens 402 is stopped against the ceramic sleeve 406. Repeat this process for 3 more times so that each position (bore hole) has a lens 402 in place.

In the example illustrated in FIG. 4, the insert 404 further comprises a pin hole 425.

Turning the brass insert 404 back over, so that it is face down, position an insert guide pin 403 into the press tool and align the insert guide pin 403 with the pin hole 425 inside of the brass insert 404. Firmly press the insert guide pin 403 into the insert 404 as far as the tool will allow.

Add an insert o-ring 405 onto the outside of the insert 404 in the designated groove.

The above steps form a first sub-assembly.

### Terminating Fibre

Using a fibre stripping tool strip back the outer jacket, revealing the Kevlar and fibre cores. Separate the Kevlar from the fibre and cut back the Kevlar using Kevlar sheers, so that there is 8 mm still visible.

Take 4 springs 409 and place one on each of the fibre leads which are now exposed.

Using the fibre stripping tool strip back 20 mm of fibre sleeve and its protective coating, leaving the 50 μm fibre bare. Clean the fibre with an IPA applied to a lint free swab. Carefully place a ferrule 407 and ferrule back end 408 over the exposed fibre to ensure the clear passage, and remove the ferrule 407 and ferrule back end 408.

Use a syringe filled with epoxy, place the ferrule 407 and ferrule back end 408 over the tip of the prepared syringe and hold it upright, squeezing adhesive into the ferrule 407 until it becomes convex, and wipe away excess epoxy from the ferrule 407.

When cleaned, position an oven sleeve onto the end of the ferrule 407 before reapplying the ferrule 407 and ferrule back end 408 onto the exposed fibre until it reaches the stripped fibre sleeve. Ensure the epoxy has covered the inside by spinning the ferrule 407 two times whilst holding it upright. Secure the ferrule back end 408 to the fibre jacket with a small cut of tape.

Repeat this process for the 3 other fibre leads, so all of them have a ferrule 407 and ferrule back end 408 at the end, and carefully place these into a multi-cure oven for a minimum of 5 minutes.

### Cleaning Fibre

Remove the fibre from the multi-cure oven and leave to cool. When cool, remove the oven sleeve from the ends of the ferrule, exposing the fibre core again. Use a ceramic blade to carefully sheer the end of the fibre, aiming to leave approx. 1 mm of cleanly sheered fibre out of the end of the ferrule.

Holding the ferrule upright; use a small piece of course lapping film held perpendicular to the fibre, gently polish the end of the fibre using circular motions applying minimal pressure to remove the adhesive.

Use a digital fibre scope to inspect the ferrule until all of the epoxy has been removed, and repeat this process for all of the ferrules. Afterwards, set up the polishing machine which will have fresh lapping film graded: 3 μm, 1 μm and 0.5 μm. Place the first puck (3 μm) into the polishing machine and position 2 ferrules within the polishing plate and place the plate into position and switch on the machine for 45 seconds. Replace the puck and repeat the process with the second puck (1 μm) for another 45 seconds. Then, replace the puck with the final puck (0.5 μm) and polish for 30 seconds.

Repeat the polishing machine process with the other two ferrules.

After all ferrules are polished; clean with an IPA and dry with a lint free cloth. Inspect the ferrules using a digital fibre scope to ensure a clean finish.

### Housing I

Starting from the back; feed the fibre through the outer housing 423 until the housing is beyond the stripped cable jacket so it is in contact with the outer jacket of the lead. Repeat this process with the cable cage 422, cable seal 421, and lock ring 414. Making sure to feed the fibre through these parts in that order, place the outer housing internal o-ring 415 and the outer housing external o-ring 416 into their designated positions around the outer housing 423 and the front seal 413 onto the lock ring 414.

### Crimping

Feed the ferrules and fibre lead through the inner crimp 420 until it meets the outer jacket of the lead. Then, ensuring the exposed Kevlar is over the inner crimp 420, position the outer crimp 417 over the inner crimp 420 and the folded over Kevlar. Using the correct crimping device, crimp the outer crimp 417 to the inner crimp 420 ensuring the Kevlar is secured in place.

### Housing II

Feed the ferrules and fibre lead through the inner housing front portion 419 and then secure the inner housing cut-out portion 418 in place by pushing them together.

Place the wave spring 412 over the end of the ferrules 407, to be around the fibre leads.

### Ferrule Positioning

One at a time, carefully place a ferrule 407 into the ceramic sleeves 406 in the insert 404, making sure not to grip too tightly onto the fibre. Push the ferrules 407 in until feeling resistance, which should indicate the fibre butting up against the back of the lens 402.

Once all ferrules 407 are secure, slide the springs 409 into position at the back of the brass insert 404. Then, position the back-end plate 410 behind the springs 409, ensuring the fibre leads are running through the allotted positions. Bolt the back-end plate 410 to the back of the brass insert 404 using a bolt 411, until tight. Bring the wave spring 412 up the leads so that it sits on the back of the back-end plate 410.

### Housing III

Attach the first sub assembly—via the back end plate 410—to the inner housing portions which are around the lead, creating a second sub assembly. Now feed the second sub assembly through the outer housing front 401, until the face of the brass insert 404 is flush with the front edge of the housing.

Place the outer housing internal o-ring 415 into its position on the outer housing front part 401. Bring up the lock ring 414, and position it over the top of the outer housing front 414, using its dedicated slots. Now, bring the outer housing rear portion 423 to meet the rest of the assembly and screw the front portion 401 to the rear portion 423.

Although the present invention has been described hereinabove with reference to specific embodiments, the present invention is not limited to the specific embodiments and modifications will be apparent to a skilled person in the art which lie within the scope of the present invention. Any of the embodiments described hereinabove can be used in any combination.

1. An expanded beam fibre optic connector comprising:
an insert comprising one or more cylindrical insert bores, each insert bore having an insert bore diameter along a length of the insert bore;
a sleeve disposed in each insert bore, the sleeve having a sleeve outer diameter, the sleeve further comprising a cylindrical sleeve bore having a sleeve bore diameter;
wherein each sleeve bore is configured to receive a ferrule, in use, each ferrule having a ferrule outer diameter, wherein the ferrule outer diameter is smaller than the sleeve bore diameter; and
a lens disposed in each insert bore, each lens having a lens outer diameter substantially the same as the sleeve outer diameter;
wherein each sleeve and each lens is held in a press fit engagement.

2. The expanded beam fibre optic connector of claim 1, wherein, in use, each ferrule abuts a respective lens.

3. The expanded beam fibre optic connector of claim 1, wherein each sleeve comprises ceramic.

4. The expanded beam fibre optic connector of claim 1, wherein the insert comprises brass.

5. The expanded beam fibre optic connector of claim 1, wherein the sleeve bore diameter is configured to provide a close clearance fit between each sleeve and respective ferrule, in use.

6. The expanded beam fibre optic connector of claim 1, further comprising:
a removable rear plate affixed to the insert; and
a spring for each insert bore;
wherein, in use, each spring is arranged between the rear plate and the respective ferrule, and surrounding a respective ferrule back end, to provide a force that urges the ferrule towards the lens.

7. The expanded beam fibre optic connector of claim 1, wherein a refractive index of each lens is at least 1.85 at a wavelength of 850 nm.

8. A method of manufacturing an expanded beam fibre optic connector, the method comprising:
forming an insert;
forming one or more cylindrical insert bores, each insert bore having an insert bore diameter along a length of the insert bore;
providing a sleeve for each insert bore, each sleeve having a sleeve outer diameter; and
each sleeve further comprising a cylindrical sleeve bore having a sleeve bore diameter, wherein each sleeve bore is configured, in use, to receive a ferrule, each ferrule having a ferrule outer diameter, wherein the ferrule outer diameter is smaller than the sleeve bore diameter; and
providing a lens for each insert bore, each lens having a lens outer diameter substantially the same as the sleeve outer diameter;
press fitting one of the sleeves and one of the lenses into each insert bore.

9. The method of claim 8, wherein each sleeve comprises ceramic.

10. The method of claim 8, wherein the insert comprises brass.

11. The method of claim 8, wherein the sleeve bore diameter is configured to provide a close clearance fit between each sleeve and respective ferrule, when the connector is in use.

12. The method of claim 8, further comprising:
forming a removable rear plate configured to be affixed to insert; and
providing a spring for each insert bore, each spring configured, when the connector is in use, to be arranged between the rear plate and the respective ferrule, and surrounding a respective ferrule back end, to provide a force that urges the ferrule towards the lens.

13. The method of claim 8, wherein a refractive index of the lens is at least 1.85 at a wavelength of 850 nm.

14. A cable management system for an expanded beam fibre optic connector, the cable management system comprising:
an inner housing having a bore and in inner surface, a portion of the inner surface having a first engagement surface;
an outer housing, the outer housing comprising a front portion and a removable rear portion;
an insert housed in the inner housing, the insert being configured, in use, to hold a termination of one or more optical fibres of an optical fibre cable; and
an inner crimp configured, in use, to grip an outer jacket of the optical fibre cable;
wherein an outer surface of the inner crimp comprises a second engagement surface configured, in use, to engage with the first engagement surface for preventing rotation of the inner housing relative to the optical fiber cable.

15. The cable management system of claim 14, wherein the inner housing comprises a removable portion.

16. The cable management system of claim 14, wherein the inner housing is transparent or translucent.

17. The cable management system of claim 14, wherein the first engagement surface defines a cavity having a polygonal cross section in a plane perpendicular to a longitudinal axis of the inner housing; and
wherein the second engagement surface defines a portion of the inner crimp having a correspondingly-shaped polygonal cross section in a plane perpendicular to a longitudinal axis of the inner crimp.

18. The cable management system of claim 17, wherein the polygonal cross section is a hexagonal cross section.

19. The cable management system of claim 14, wherein the outer housing rear portion is rotatable independently of the inner housing and the optical fibre cable.

20. The cable management system of claim 14, wherein the insert comprises one or more cylindrical insert bores, each insert bore having an insert bore diameter along a length of the insert bore; and wherein the cable management system further comprises:
a sleeve disposed in each insert bore, the sleeve having a sleeve outer diameter, the sleeve further comprising a cylindrical sleeve bore having a sleeve bore diameter;
wherein each sleeve bore is configured to receive a ferrule, in use, each ferrule having a ferrule outer diameter, wherein the ferrule outer diameter is smaller than the sleeve bore diameter; and
a lens disposed in each insert bore, each lens having a lens outer diameter substantially the same as the sleeve outer diameter;
wherein each sleeve and each lens is held in a press fit engagement.
